(19) United States
(12) Patent Application Publication
(10) Pub. No.: US 2009/0120249 A1
(43) Pub. Date: May 14, 2009

(54) Device For Refining Workpieces

(76) Inventors: Achim Gauss, Dornstetten/Hallwangen (DE); Ludwig Albrecht, Dornstetten-Aach (DE); Johannes Schmid, Starzach/Wachendorf (DE)

Correspondence Address: BAKER BOTTS L.L.P., 30 ROCKEFELLER PLAZA, 44TH FLOOR, NEW YORK, NY, 10112-4498, US

(21) Appl. No.: 11/940,135

(22) Filed: Nov. 14, 2007

(51) Int. Cl. B23B 13/02; B23B 1/00; B23B 23/00; B23B 25/00

(52) U.S. Cl. 82/124; 82/1.11; 82/152; 82/162

(57) ABSTRACT

The invention relates to a device for refining workpieces, which preferably consist at least partially of wood, wood materials or the like, having an ink-jet printing means having a plurality of nozzles from which drops of ink can be expelled, a workpiece carrier means for carrying the workpiece to be patterned, a conveyor device for bringing about a relative movement between the workpiece to be refined and the printing means. The device according to the invention is characterised in that it further has at least one machining means for machining the workpiece.

### TECHNICAL FIELD

The invention relates to a device for refining workpieces, which preferably consist at least partially of wood, wood materials or the like, according to the preamble of claim 1.

### PRIOR ART

A device of the type mentioned at the outset is known, for example, from DE 100 31 030 B4. In this device, workpieces are delivered and deposited on a conveyor device. In order to detect the positioning of the workpieces on the conveyor device, the device has stationary sensors which are attached to the conveyor device or to a portal. These sensors also have to detect the geometry of the workpieces, or the geometrical data has to be transmitted and read in by an upstream machining apparatus and transformed in view of the new positioning data of the sensors. This leads to high design and procedural costs.

Furthermore, European patent application EP 05 009 326.9, which was filed by the Applicant and has not yet been published, also relates to a device according to the preamble of claim 1.

### PRESENTATION OF THE INVENTION

The object of the present invention is therefore to provide a generic device for refining workpieces that allows a high refining quality with a simple design and simple operation.

According to the invention, this object is achieved by a device for refining workpieces according to claim 1.

Particularly advantageous developments of the invention are specified in the dependent claims.

The underlying idea of the invention is to avoid as far as possible during refinement rechucking of the workpieces to be refined. For this purpose, provision is made in accordance with the invention for a generic device also to have at least one machining means for machining the workpiece. In this way, it is possible not only to imprint the workpieces in the device according to the invention but also to carry out individual or numerous machining processes which can be performed before, after or else during the printing process. Rechucking between these refining steps may thus be dispensed with, so no repeated workpiece orientation and/or sensor detection is required, and this simplifies the design of the overall device and the operation thereof without impairing the refining quality.

Although within the scope of the invention the use of at least one ink-jet printing means is preferred, other printing means can also be used alternatively or additionally.

Within the scope of the invention, it is in principle possible to dispose the ink-jet printing means and/or the machining means stationarily and to guide the workpieces to be refined along the machining means using the conveyor device. It is also possible to configure the printing means and/or the machining means so as to be movable or else to provide a combination of both variations, i.e. both the workpieces and the printing means and/or the machining means are moved during the printing or machining process using the conveyor device.

Within the scope of the present invention, the machining means for machining the workpiece can have a broad range of configurations and be configured for one or more types of machining.

With regard to the workpieces which are preferably to be refined in the present case and consist at least partially of wood, wood materials or the like, it has proven advantageous, in accordance with a development of the invention, for the machining operations for which the machining means is configured to be selected, for example, from at least material removal, edge-banding, extruding, coating, laminating, cleaning, degreasing, improving adhesive and wetting properties, and reducing electrostatic charging. For carrying out the following types of machining: cleaning, degreasing, improving adhesive and wetting properties and reducing electrostatic charging, reference is made to the European patent application filed by the Applicant and having the No. 06 004 713.1, the priority of which is claimed. It should also be noted that, within the scope of the invention, other types of machining can alternatively or additionally be used, in particular those for preparing and/or subsequently treating the imprinted workpiece or workpiece to be imprinted.

Within the scope of the present invention, the conveyor device can also be configured in a broad range of ways, for example by an individual workpiece conveyor table, but also by a large number of movable components which can be moved in relation to one another. However, according to a development of the invention, it is preferred that the conveyor device is configured also to bring about a relative movement between the workpiece to be refined and the machining means, preferably in such a way that the workpiece can be machined and imprinted without changing its position relative to the workpiece carrier means. In this way, rechucking during refinement of the workpieces to be refined can be avoided in the device according to the invention, thus producing a simple and precise operation with high refining quality.

In the device according to the invention, the ink-jet printing means and the machining means can in principle be positioned at any desired point, including for example on a movable or stationary robot. They can also be fixedly built on. According to a development of the invention, provision is made for the device to have at least one beam-like means for guiding the printing means and/or the machining means, in particular a portal or a jib. In this way, this printing means or the machining means can be positioned without difficulty at any desired point and, in addition, optionally be moved along the beam-like guide means. Furthermore, the beam-like guide means can advantageously be used to receive a spindle unit provided in accordance with a development of the invention, the spindle unit preferably being movable on the beam-like guide means and/or preferably being pivotable about at least one axis.

A spindle unit of this type is highly suitable as a basic component of a machining means, especially in combination with a plurality of machining tools and/or installations which can preferably be inserted into the at least one spindle unit and can particularly preferably be deposited in at least one magazine. This gives rise, with low design costs, such as for example a small number of drives, to a broad range of possibilities for machining the workpieces.

In addition, the at least one spindle unit can be used not only for operating a broad range of machining tools and/or installations but also for operating a printing unit. For this purpose, there is provided in accordance with a further objective of the invention a printing unit which can be inserted into the at least one spindle unit, in particular via an interface. As a result, the printing unit can also be flexibly inserted and brought into an operating position in the spindle unit only when it is required for refining the workpiece. In order to allow secure insertion of the printing unit into the spindle unit, a development of the invention provides for the printing unit to have connection means by which it can be inserted into the tool receptacle of a spindle unit. The spindle unit thus does not have to be adapted for receiving the printing unit; instead, the printing unit has suitable connection means which can be included in the tool receptacle, which is present anyway, of the spindle unit.

According to a development of the invention, an insertable printing unit of this type further has transfer means which are configured to communicate with transfer means of an interface of the respective spindle unit. In this way, it is not necessary to link the printing unit via cables, sliding contacts, hoses or the like. As a result, not only is the design of a device according to the invention not impeded by cables, hoses or the like; the insertion and replacement of the printing unit into a spindle unit or a magazine is facilitated. According to the invention, it is in this case particularly preferred that the transfer means are configured to receive at least data and/or power and/or ink from the transfer means of the spindle unit.

Alternatively or additionally, a development of the invention further provides that the printing unit has an ink reservoir. This makes operation of the printing unit more independent of a supply of ink and thus prompter and more reliable. However, this does not rule out the possibility of the printing unit being supplied with ink from the outside or via an interface of a spindle unit, for example in that the ink reservoir of the printing unit is filled at regular intervals or continuously from outside or via the interface.

Furthermore, alternatively or in addition to the transfer of data via the transfer means/interface, the printing unit can be configured, in accordance with a development of the invention, for wireless data transfer from and/or to a control means. As in the foregoing configurations, this provides a simple design and trouble-free operation of the printing unit according to the invention and the device according to the invention.

According to a development of the invention, the printing unit further has at least one sensor, in particular at least one distance sensor and/or at least one image detection sensor. This objective is based on the finding that distortion and smudging of the printed image occur, in the case of workpieces in known devices or having known printing units, above all as a result of the fact that the print head and workpiece are not positioned with sufficient precision relative to each other, so printing is carried out with imprecise “register”. For example, this leads to certain regions of the workpiece being imprinted twice or an overspray being produced, i.e. printing is carried out beyond a free edge of the workpiece and ink mist is deposited on an adjacent surface of the workpiece. These problems can be eliminated or at least greatly reduced by the presence of at least one sensor, as precise relative positioning, adapted to the actual geometry and position of the workpiece and the printing progress, between the print head and workpiece can be achieved.

Furthermore, the present invention provides a method for refining workpieces using a device according to the invention, which method is characterised in that the respective workpiece is machined and imprinted while maintaining a predetermined position relative to the workpiece carrier means. The method according to the invention also allows the above-described advantages over the prior art to be achieved.

### BRIEF DESCRIPTION OF THE DRAWINGS

FIG. 1 is a schematic perspective view of a device for refining workpieces according to an embodiment of the invention;

FIG. 2 is a schematic partial plan view of the device shown in FIG. 1;

FIG. 3 is a schematic, partially cut-away front view of the device shown in FIG. 1;

FIG. 4 shows further details of the printing means of the device shown in FIG. 1;

FIG. 5 shows further details of the printing means of the device shown in FIG. 1; and

FIG. 6 illustrates the operation of the device shown in FIG. 1.

### DETAILED DESCRIPTION OF PREFERRED EMBODIMENTS

Preferred embodiments of the present invention will be described hereinafter in detail with reference to the accompanying drawings.

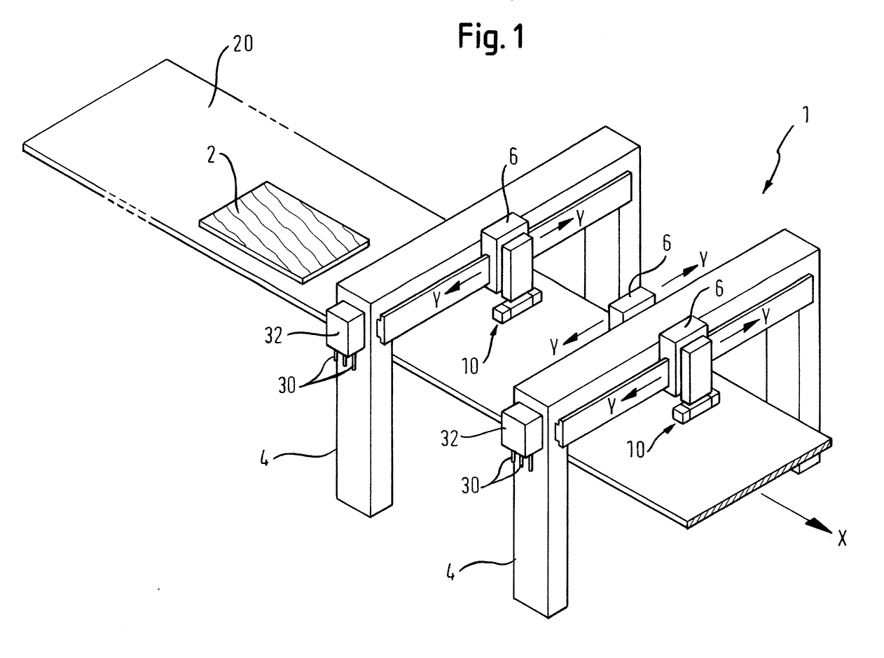

FIG. 1 is a schematic perspective view of a device 1 for refining workpieces 2 as a preferred embodiment of the present invention. The device is used for machining and patterning workpieces 2 which, in the present embodiment, consist at least partially of wood, wood materials, plastics materials or the like, such as are frequently used in the field of furniture and structural elements.

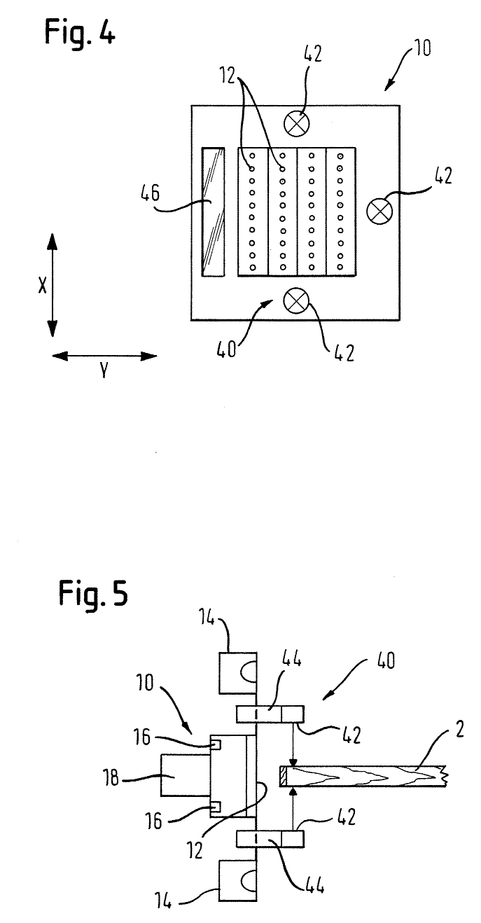

The device 1 comprises an ink-jet printing means 10 which, in the present embodiment, operates in accordance with the drop-on-demand principle. As may be seen most clearly in FIG. 4, the ink-jet printing means 10 comprises a plurality of nozzles 12 from which drops of ink can be expelled and which, in the present embodiment, are disposed in a plurality of rows, each row being provided for expelling a predetermined colour, for example the colours cyan, magenta, yellow and black.

Also provided on the printing means 10 are drying units 14, for example UV driers, which are used promptly to dry the ink applied by the printing means in order to prevent possible printing with imprecise ‘register’.

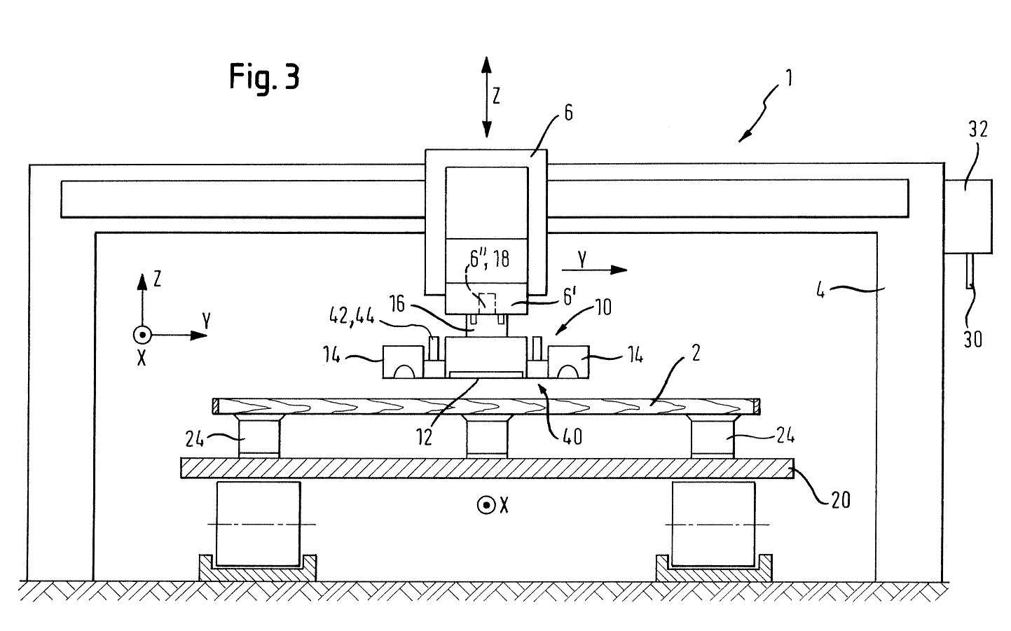

The printing means 10 is in the present embodiment provided on or inserted into a spindle unit 6, as may be seen most clearly in FIG. 3. The spindle unit is preferably a spindle unit which is also suitable for the insertable and exchangeable receiving of machining tools or machining installations and which, for this purpose, has a tool receptacle 6′ and an interface 6″, wherein the interface can, for example, be configured to transfer data, power, drive, fluids, etc.

In order to allow the printing means (printing unit) 10 to be inserted into the spindle unit, the printing unit 10 is provided in the present embodiment with a connecting piece 18 which can be inserted into the tool receptacle 6′ of the spindle unit (cf. FIG. 3). Furthermore, the printing unit 10 has transfer means 16 (cf. FIG. 3) which are able to communicate with the interface 6″ of the spindle unit. This allows, for example, data, power, drive, fluids, etc. and, in particular, also ink to be transferred. In addition, the printing unit 10 can have an ink reservoir and/or a wireless data transfer means, although this is not shown in the figures.

The spindle unit 6 is provided so as to be movable in the y direction on a portal 4 which can itself, in turn, be configured so as to be movable in the x direction. There are in this case provided in the present embodiment two portals 4, each of which can carry one or more spindle units 6 which can optionally be disposed on opposing sides of the respective portal 4. It should be noted in this regard that the portals 4 can also optionally be configured as jibs.

The spindle units 6 can be automatically or manually fitted, via tool magazines 32 respectively provided at the portals 4, with machining tools and/or machining installations 30 and also one or more printing units 10 (FIG. 3). In other words, the printing units 10 are configured in such a way that they can also be deposited in the magazines 32.

Within the scope of the present embodiment, use may be made of a broad range of machining tools 30 and/or machining installations 30 such as, for example, cutting tools (drills, milling cutters, etc.), edge-banding installations, extruding installations, coating installations, laminating installations, cleaning installations, degreasing installations, installations for improving the adhesive and wetting properties of the surfaces to be imprinted, and installations for reducing the electrostatic charging of the surfaces to be imprinted. Obviously, these tools and installations can also be fixedly built on (independently of a spindle unit). For carrying out the following types of machining: cleaning, degreasing, improving adhesive and wetting properties and reducing electrostatic charging, reference is made to the European patent application filed by the Applicant and having the No. 06 004 713.1, the priority of which is claimed.

In the present embodiment, there extends below the portals 4 a workpiece table 20 for carrying the respective workpieces 2 to be patterned, which table is movable in the x direction shown in FIG. 1. The workpiece table 20 can have a broad range of configurations and, for example, also be formed by a circulating conveyor belt or the like. On account of its movability, the workpiece table 20 forms at the same time a workpiece carrier means and a portion of the conveyor device according to the present invention.

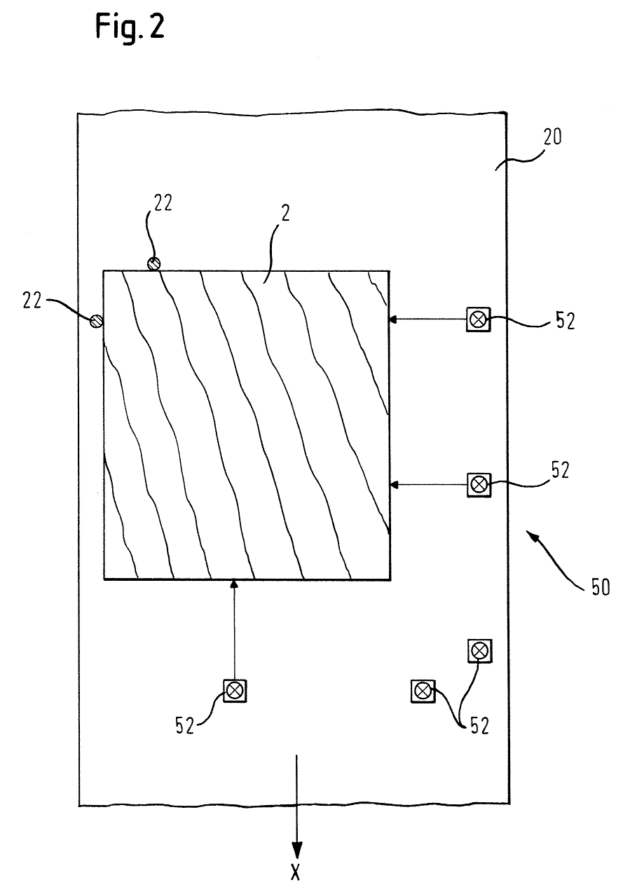

FIG. 2 is a detailed plan view of the disposal of a plate-like workpiece 2 on the workpiece table 20. In the present embodiment, the workpiece table 20 has extensible stop pins 22 against which the workpiece 2 can be placed for rough positioning. Also disposed on the workpiece table 20 is a plurality of distance sensors 52 which are part of a rough detection means 50. The distance sensors shown in FIG. 2 are configured to detect the distance between the sensors and a lateral surface (narrow surface) of each workpiece 2. In the present embodiment, the sensors 52 are in this regard rotatable about an axis extending orthogonally to the surface of the workpiece table 20 and are optionally movable parallel to the surface. The rough detection means 50 is thus used for roughly detecting the geometry and positioning of each workpiece 2.

Further details of the workpiece table 20 are shown in FIG. 3 which is a partially cut-away front view of the device shown in FIG. 1. It may be seen from FIG. 3 that the respective workpiece 2 may be fixed on the workpiece table 20, for example via vacuum suction means 24. It is also possible to integrate appropriate suction means or suction openings into the workpiece table or a workpiece belt.

The device 1 according to the invention further comprises a detection means 40 for detecting the relative position of the ink-jet printing means 10 and the respective surface to be patterned of a workpiece 2. In the present embodiment, the detection means 40 has a plurality of types of sensors 42, 46 which can be seen most clearly in FIGS. 3, 4 and 5. In the present embodiment, the detection means 40 comprises first of all three distance sensors 42 which are disposed on the printing means 10 adjacently to the nozzles 12 and measure in a direction substantially parallel to the direction in which ink is expelled from the nozzles 12 (FIG. 4). On the one hand, these distance sensors can be used to determine the absolute distance between the printing means 10 and the workpiece 2; however, in addition, the precise contour of each workpiece 2 can also be inferred from the distance data obtained.

As may be seen most clearly in FIGS. 3 and 5, further distance sensors 42 are disposed on the printing means 10, in each case via an element 44 which, in the present embodiment, is able to pivot. The pivotable element 44 allows each sensor to be brought into an extended position which can be seen most clearly in FIG. 5. In this position, the sensors 42, shown in FIG. 5, measure in a direction substantially orthogonal to the direction in which ink is expelled from the nozzles 12. This allows the thickness or height of each region to be imprinted to be detected and an overspray to be avoided.

In addition, in the present embodiment, there is disposed on the printing means 10, adjacently to the ink expelling nozzles 12, an image detection sensor 46 which also measures in a direction substantially parallel to the direction in which ink is expelled from the nozzles 12. The image detection sensor 46 may, for example, be a CCD camera or the like which can produce a complete image of a region of the respective workpiece 2 that is to be imprinted or has already been imprinted.

Although not shown in the figures, all of the sensors, on the one hand, and the printing means and preferably also the remaining operating components of the device 1, on the other hand, are connected to a control means which evaluates the respective data collected by the sensors and on this basis controls the operation of the device, in particular of the printing means. The device may in this regard be operated as follows.

First of all, a workpiece 2 is roughly positioned on the workpiece table 20 via the stop pins 22 and fixed via the vacuum suction means 24. Subsequently, the positioning and/or contour of the workpiece 2 on the workpiece table 20 are detected by the sensors 52 and this data is forwarded to the control means.

The workpiece table 20 is then moved in the x direction, so the workpiece 2 can be machined or refined by tools, installations or printing units inserted into the spindle units 6. In this regard, the printing means is, for example, operated as follows.

Based on the data from the sensors 52, the printing means 10 is moved with the corresponding spindle 6 along the portal 4 to the workpiece 2 to be imprinted. In this regard, the sensors 42, 46 continuously perform a measuring operation, thus allowing the presence and, if appropriate, the distance of each workpiece and, in addition (by way of the image detection sensor 46), further information about the workpiece 2 to be obtained. Based on this data, the control means issues print signals to the respective nozzles 12 (or the associated piezoelectric actuators or thermocouples), so the workpiece 2 is imprinted. Individual nozzles or groups of nozzles can in this regard be switched on or off as a function of the detection data of the sensors 42, 46 in order to compensate for dimensional, positional or other tolerances or deviations of the workpiece 2. Alternatively or additionally, it is also possible, within the scope of the invention, for individual nozzles or a plurality of nozzles of the printing means 10 to be produced via piezo adjustment means or the like, in order to adapt the position or direction of expulsion thereof to the workpiece 2.

When imprinting a large lateral surface of a workpiece 2, there operate, in addition to the image detection sensor 46, primarily the sensors 42 which are disposed next to the nozzles 12 and can be seen most clearly in FIG. 4. In order to imprint a narrow surface of the workpiece 2, use is alternatively or additionally made of the sensors 42 which are extensible via pivotable elements 44 in order to detect the height of the narrow surface and thus to prevent an overspray.

Once a surface portion has been imprinted, it can optionally be dried by the drying units 14, if necessary simultaneously to the printing process.

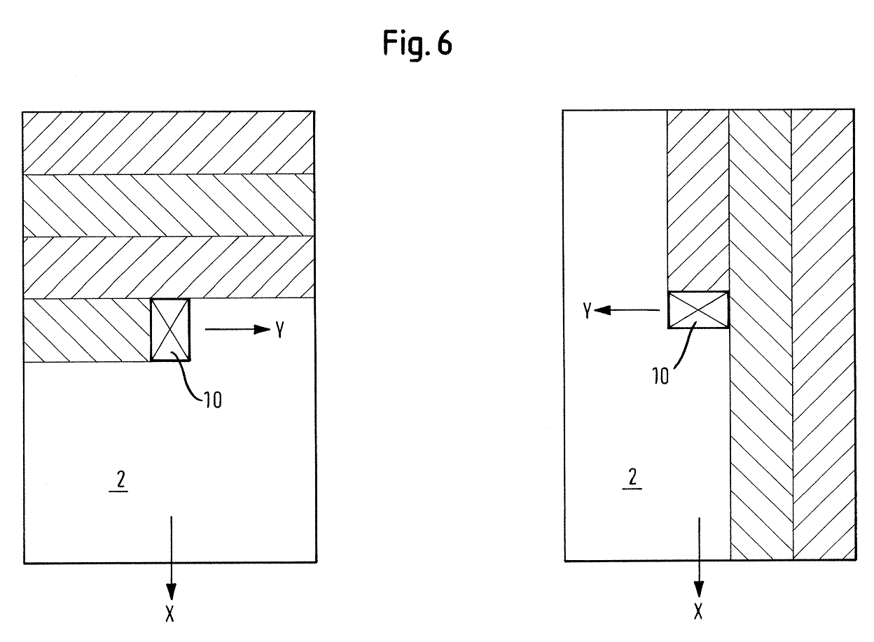

FIG. 6 illustrates schematically the paths of movement of the printing means 10 and/or the workpiece 2. The left-hand drawing in FIG. 6 shows an operation in what is known as transverse printing in which the printing means 10 moves back and forth in the y direction, together with the spindle unit 6, along the portal 4, and the workpiece table 20 further clocks the workpiece 2 in the x direction.

Alternatively, it is also possible to use the printing model which is shown on the right-hand side in FIG. 6 and is referred to as longitudinal printing. In this model, the printing means 10 is itself substantially stationary during the printing process, and the workpiece 2 is moved back and forth in the x direction with the workpiece table 20. The printing means 10 has therefore merely to be further clocked in the y direction once the printing of a web is completed. In addition, within the scope of the present invention, combinations of both operations are also possible, and webs disposed, for example, obliquely or the like can be printed.

1-14. (canceled)

15. A device for refining wood or wood-containing workpieces, comprising:
an ink jet printer having a plurality of nozzles from which drops of ink can be expelled;
a workpiece carrier for carrying the workpiece to be patterned; and
a conveyor device for bringing about a relative movement between the workpiece to be refined and the inkjet printer, wherein the device further comprises at least one machining means for machining the workpiece.

16. The device according to claim 15, wherein the machining means is configured to carry out machining operations selected from the group consisting of material removal, edge-banding, extruding, coating, laminating, cleaning, degreasing, improving adhesive and wetting properties, and reducing electrostatic charging.

17. The device according to claim 15, wherein the conveyor device is configured to bring about a relative movement between the workpiece to be refined and the machining means in such a way that the workpiece can be machined and imprinted without altering its position relative to the workpiece carrier.

18. The device according to claim 15, further comprising a portal or a jib.

19. The device according to claim 18, further comprising:
at least one spindle unit which is movable along a beam-like guide and/or pivotable about at least one axis.

20. The device according to claim 15, further comprising:
a plurality of machining tools and/or installations which can be inserted into the at least one spindle unit and can be deposited in at least one magazine.

21. The device according to claim 15, wherein the inkjet printer can be inserted into the at least one spindle unit via an interface.

22. The device according to claim 15, wherein the inkjet printer further comprises connection means by which it can be inserted into the tool receptacle of a spindle unit.

23. The device according to claim 22, further comprising:
transfer means which are configured to communicate with an interface of the at least one spindle unit.

24. The device according to claim 23, wherein the transfer means are configured to receive at least data and/or power and/or ink from the spindle unit.

25. The device according to claim 22, further comprising:
an ink reservoir.

26. The device according to claim 22, wherein the device is configured for wireless data transfer from and/or to a control means.

27. The device according to claim 22, further comprising:
at least one distance sensor and/or at least one image detection sensor.

28. A method for refining wood or wood-containing workpieces using a device according to claim 15, wherein the workpiece is machined and imprinted while maintaining a predetermined position relative to the workpiece carrier.

29. The device according to claim 16, wherein the conveyor device is configured to bring about a relative movement between the workpiece to be refined and the machining means in such a way that the workpiece can be machined and imprinted without altering its position relative to the workpiece carrier.

30. The device according to claim 23, further comprising:
an ink reservoir.

31. The device according to claim 24, further comprising:
an ink reservoir.

32. The device according to claim 23, wherein the device is configured for wireless data transfer from and/or to a control means.

33. The device according to claim 24, wherein the device is configured for wireless data transfer from and/or to a control means.

34. The device according to claim 25, wherein the device is configured for wireless data transfer from and/or to a control means.

35. The device according to claim 30, wherein the device is configured for wireless data transfer from and/or to a control means.

36. The device according to claim 31, wherein the device is configured for wireless data transfer from and/or to a control means.
